(19) United States
(12) Patent Application Publication
(10) Pub. No.: US 2008/0030785 A1
(43) Pub. Date: Feb. 7, 2008

(54) FANTASY SPORT POSTER SYSTEM

(76) Inventor: Arnold Kuchenmeister, Brook Park, OH (US)

Correspondence Address: HOWARD M COHN;PATENT ATTORNEY LLC, 21625 CHAGRIN BLVD #220, CLEVELAND, OH, 44122, US

(21) Appl. No.: 11/834,114

(22) Filed: Aug. 6, 2007

Related U.S. Application Data
(60) Provisional application No. 60/821,594, filed on Aug. 7, 2006.

(51) Int. Cl. G06F 15/04

(52) U.S. Cl. 358/1.18

(57) ABSTRACT

The present invention relates to a method and system of generating a poster on a website. A poster design website is accessed on which a personalized poster can be designed. A sport can be selected from a list of sports on a landing page. A poster template can be selected from the website. Selected images of particular players, list of plays and maneuvers for the selected sport, and statistics of each of the selected players are accessed from the internet and moved onto a holding location on the landing page. A trophy from a trophy page on the design website is selected and moved onto the holding location on the landing page. The selected poster template is then populated with images of the saved information on the holding location to form a completed poster.

### CROSS-REFERENCE TO RELATED APPLICATIONS

This application claims the benefit of U.S. Provisional Patent Application No. 60/821,594 filed on Aug. 7, 2006 which is incorporated herein by reference.

### TECHNICAL FIELD

The present invention generally relates to a method and system for generating posters and more particularly to a method and system for generating a fantasy poster for a team owner of a Fantasy Sports Team.

### BACKGROUND OF THE INVENTION

The competition and excitement of professional sports engenders a religious following amongst millions of fans. Fans score the performance of players and teams season after season. These fans frequently organize formal and informal pools to capitalize on their own knowledge of the game and their desire to compete with other fans. As a result of this keen interest, numerous football games have been devised to mimic various aspects of professional football. Generally in such games, participants select, or “draft,” currently active real-life athletes to form fantasy teams. A participant's success or failure in the game corresponds to the performance of the players in real-life games. Owners of such fantasy teams may compile won-lost records by competing head to head against each of the other teams in a league of other owners of fantasy teams. The winning team each week is determined by which team's players performed better during the previous week.

The owner of a Fantasy Sports team is often passionate about his/her team and wants to commemorate the season or success in some way.

Accordingly, it is an object of the present invention to provide a method for a team owner of a Fantasy Sports team to celebrate the team that he/she has selected.

### SUMMARY OF THE INVENTION

According to the present invention there is disclosed a method of generating a poster on a website, comprising the steps of:

accessing a poster design website on which a personalized poster can be designed;

selecting a sport from a list of sports on a landing page;

selecting a poster template on the poster design website;

accessing photographs of a plurality of players of the selected sport from on the internet and selecting images of particular players and moving the selected images onto a holding location on the landing page;

accessing a list of plays and maneuvers for the selected sport from the internet and moving the selected list of plays and maneuvers onto the holding location on the landing page;

retrieving the statistics of each of the selected players from the internet and moving the statistics of each of the selected players onto the holding location on the landing page;

accessing a trophy page showing a variety of trophies on the sport poster design website and selecting a trophy and moving the selected trophy onto the holding location on the landing page; and

open the landing page and populating the selected poster template with images of the saved information on the holding location to form a completed poster.

Further according to the present invention, the step of accessing a poster design website includes accessing the World Wide Web from a personal computer.

Still further according to the present invention, the step of selecting a poster template on the poster design website includes selecting a poster template adapted for occupying the poster template with images, graphics, and/or text from a template page on the website.

Further yet according to the present invention, the step of selecting a sport from a list of sports on a landing page includes selecting a sport from a dropdown menu on the landing page.

Also according to the present invention, the step of moving saved information on the holding location includes moving thumbnail versions of stored information on the holding location of the landing page to the selected poster template.

Still further according to the present invention, the step of uploading pictures onto the landing page from the personal computer and saving them on the holding location.

Moreover according to the present invention, the completed poster can be purchased from a checkout page on the website.

Still further according to the present invention, the images populating the poster template can be manipulated.

Further according to the present invention, the step of creating a preview image of the populated poster template and downloading the populated poster template to the user.

Yet further according to the present invention, the step of the completing the poster template with a desired color, text and heading of the poster from a list of font types, colors, and design elements.

According to the present invention, there is disclosed a poster generation system, comprising:

means for accessing a poster design website on which a personalized poster can be designed;

means for selecting a sport from a list of sports on a landing page;

means for selecting a poster template on the poster design website;

means for accessing photographs of a plurality of players of the selected sport from on the internet and selecting images of particular players and moving the selected images onto a holding location on the landing page;

means for accessing a list of plays and maneuvers for the selected sport from the internet and moving the selected list of plays and maneuvers onto the holding location on the landing page;

means for retrieving the statistics of each of the selected players from the internet and moving the statistics of each of the selected players onto the holding location on the landing page;

means for accessing a trophy page showing a variety of trophies on the sport poster design website and selecting a trophy and moving the selected trophy onto the holding location on the landing page; and means for open the landing page and populating the selected poster template with images of the saved information on the holding location to form a completed poster.

Further according to the present invention, the means of accessing a poster design website includes accessing the World Wide Web from a personal computer.

Still further according to the present invention, the means of selecting a poster template on the poster design website includes selecting a poster template adapted for occupying the poster template with images, graphics, and/or text from a template page of the website.

Yet further according to the present invention, the means of selecting a sport from a list of sports on a landing page includes selecting a sport from a dropdown menu on the landing page.

Moreover according to the present invention, the means of moving saved information on the holding location includes moving thumbnail versions of stored information on the holding location of the landing page to the selected poster template.

Also according to the present invention, there are means of uploading pictures onto the landing page from the personal computer and saving them on the holding location.

Further according to the present invention, there are means of purchasing the completed poster from a checkout page on the website.

Still further according to the present invention, there are means of manipulating the images populating the poster template.

Further yet according to the present invention, there are means of creating a preview image of the populated poster template and downloading the populated poster template to the user.

Still further according to the present invention, there are means of completing the poster template with a desired color, text and heading of the poster from a list of font types, colors, and design elements.

### BRIEF DESCRIPTION OF THE DRAWINGS

FIG. 1 is a flow chart of the necessary steps a customer must take to create a poster.

FIG. 2 is an example of a completed poster with a variety of illustrations.

### DETAILED DESCRIPTION OF THE PREFERRED EMBODIMENTS

The present invention relates to a poster generation system which includes an interaction between a computer network, i.e. the

World Wide Web, and a user of customer. The term “poster” as used herein is broadly defined as a document larger in size than a standard-sized piece of media (letter, legal, or A4).

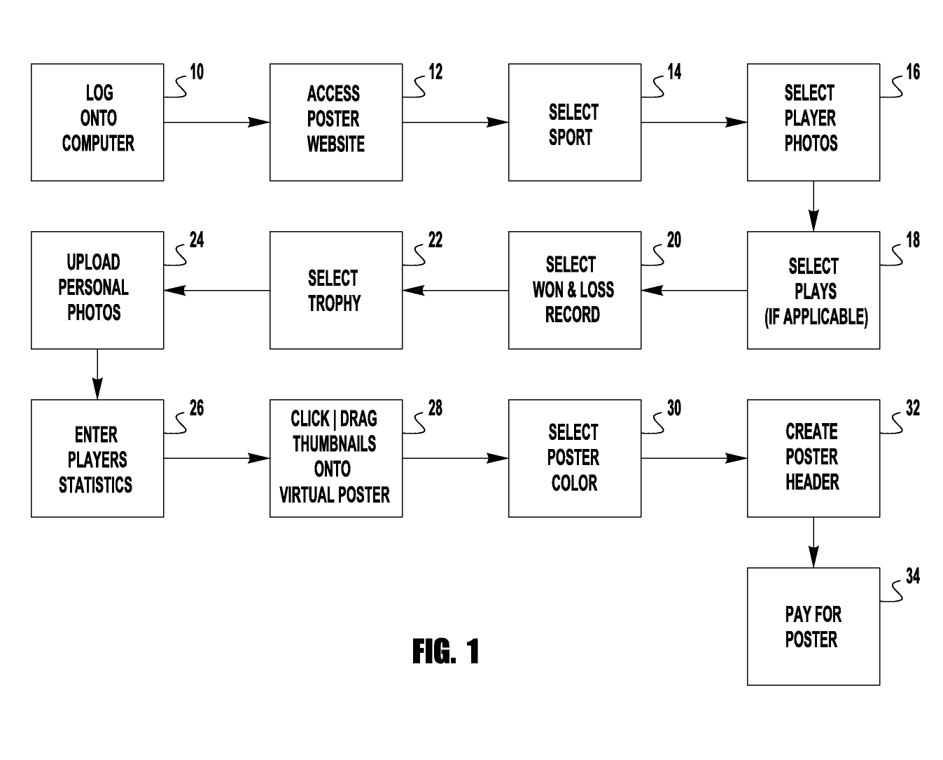

FIG. 1 illustrates the steps necessary to create a fantasy poster for a team owner of a Fantasy Sports Team.

Step 1: The poster design system begins with the user, for example the Fantasy Sports team owner, logging onto a computer, such as a personal computer, and accessing the World Wide Web. (See Block 10 in FIG. 1)

Step 2: The user accesses the Fantasy Team Sports Poster design website on which a personalized poster to celebrate the Fantasy Sports team that he/she has selected can be designed and then ordered. (See Block 12 in FIG. 1).

Step 3: The user will begin on a landing page of the Fantasy Team Sports Poster design website. The landing page can direct the user onto a page of the website having a variety of poster templates from which the user can choose. The poster template can have selected images, graphics, and/or text placed thereon. The landing page can include a holding location to store selected information and designs and allow the user to easily create the Fantasy Sports team poster. For example, the desired sport can first be selected, whether that is baseball, football, basketball, hockey, or any sport with which fantasy sports play is offered, from a drop down menu on the landing page. (See Block 14 in FIG. 1).

Step 4: Next, the user will access a page on the poster design website which allows access to the photographs of all the athletes within a particular professional sports league, such as the National Football League (NFL), which has been selected. The user can then select the photographs of each of the players he/she desires and move them onto a holding location on the landing page. The holding location will ultimately contain all of the information, pictures and designs that the user intends to use in creating his/her unique Fantasy Sports team poster. (See Block 16 in FIG. 1).

Step 5: Continuing, the user will access a page on the design website with a list of plays and maneuvers for the particular sport selected. The user can select from these plays and maneuvers and save them, as with the photographs of the players, in the holding location on the landing page. (See Block 18 in FIG. 1).

Step 6: The user will then post his/her won/loss record and/or the scores for the games in the season in the holding location on the landing page. (See Block 20 in FIG. 1).

Step 7: Next, the user can go to a trophy page of the design website and select from a variety of trophies to put on the poster. As with the previous steps, the user will post the selected trophy on the holding location on the landing page. (See Block 22 in FIG. 1).

Step 8: Continuing, the user can upload any personal pictures from a personal computer onto the landing page from their personal computer and save them on the holding location for later use. (See Block 24 in FIG. 1).

Step 9: The user can then retrieve the statistics of each of the selected players of his team from the internet and move them to the holding location on the landing page. (See Block 26 in FIG. 1).

Step 10: The user can then open a page on the website with a plurality of templates of a poster. The term “template”, as used herein, is defined as a pre-designed document format that may contain pre-selected text and/or graphics, as well as containing one or more copy openings to receive user-selected images of players, photos, graphics, and/or text. If desired, the user can also open the landing page with all of the saved information such as the photographs, the records, the plays, personal pictures and the trophy, all in thumbnail version, on the holding location. The user may click and drag the thumbnails onto the selected template of a poster and place them in any location he/she desires (See Block 28 in FIG. 1).

Step 11: The user will then select the color of the poster from a list of potential colors and cause the poster to be that color. (See Block 30 FIG. 1).

Step 12: The user may then create the heading of the poster from a list of font types, colors, and sizes. At the same time, the user can add text or change text as they desire. Further, the user can incorporate any design elements desired. The website may include controls to allow the user to manipulate the images populating the template, for example resealing the image and translating the image to allow a magnified portion of the image to appear in the copy opening of the template. (See Block 32 in FIG. 1).

Step 13: Once the poster is completed, the user can preview the final product. The image manipulation interface may be configured to create a preview image of the poster that can be downloaded to the user. The preview image may be all or part of the poster and may be printed by the user to check a sample showing the actual resolution of the poster to determine if the resolution is acceptable.

Step 14: If satisfied, the user can go on to a checkout page where the poster is purchased and shipping instructions are designated (See Block 34 in FIG. 1). If not, the user can return to any of the steps and change the information or pictures that are selected. While the series of steps are provided in order, it is within the terms of the invention for the user to use any order desired in selecting the pictures, text or design of the information that will be on the poster. Moreover, the user does not necessarily have to choose to do the actions in any of the boxes 16-26.

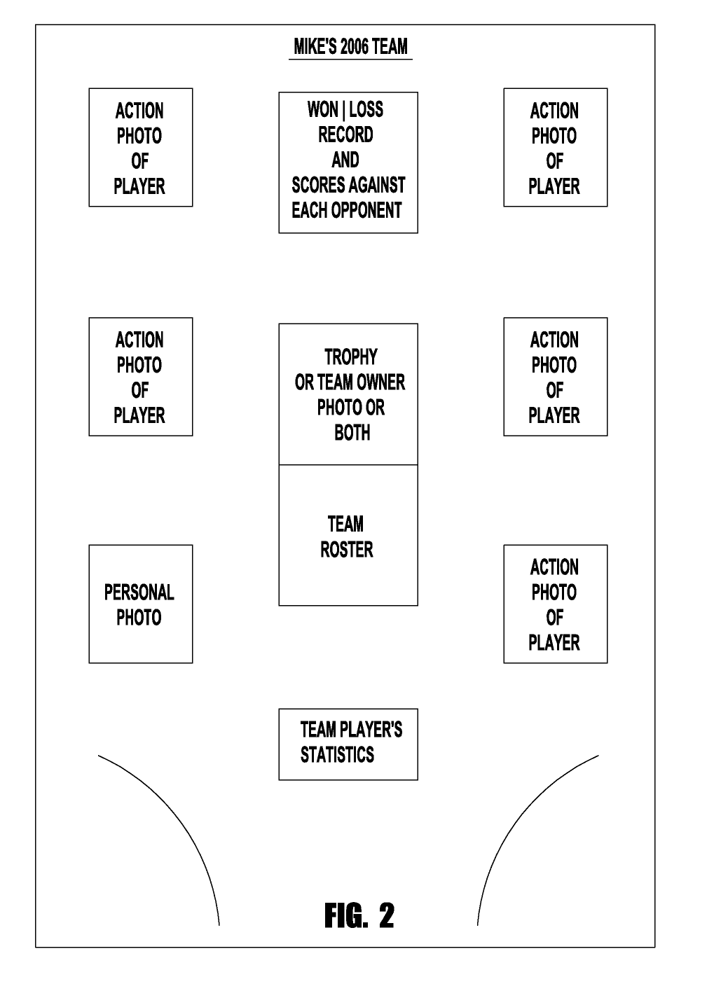

FIG. 2 illustrates a typical poster that has been custom designed. There is a heading and the size and color of the poster is customizable. It includes action photographs of professional players, won/loss record and scores versus each opposing team, a trophy, a team owner's photograph, and a team roster and player statistics.

It will be understood that the present invention may have various other embodiments. Furthermore, while the form of the invention herein shown and described constitutes a preferred embodiment of the invention, it is not intended to illustrate all possible forms thereof. It will also be understood that the words used are words of description rather than limitation, and that various changes may be made without departing from the spirit and scope of the invention disclosed. Thus, the scope of the invention should be determined by the appended claims and their legal equivalents, rather than solely by the examples given.

What is claimed is:

1. A method of generating a poster on a website, comprising:
accessing a poster design website on which a personalized poster can be designed;
selecting a sport from a list of sports on a landing page;
selecting a poster template on the poster design website;
accessing photographs of a plurality of players of the selected sport from on the internet and selecting images of particular players and moving the selected images onto a holding location on the landing page;
accessing a list of plays and maneuvers for the selected sport from the internet and moving the selected list of plays and maneuvers onto the holding location on the landing page;
retrieving the statistics of each of the selected players from the internet and moving the statistics of each of the selected players onto the holding location on the landing page;
accessing a trophy page showing a variety of trophies on the sport poster design website and selecting a trophy and moving the selected trophy onto the holding location on the landing page; and
opening the landing page and populating the selected poster template with images of the saved information on the holding location to form a completed poster.

2. The method of claim 1 wherein the step of accessing a poster design website includes accessing the World Wide Web from a personal computer.

3. The method of claim 1 wherein the step of selecting a poster template on the poster design website includes selecting a poster template adapted for occupying the poster template with images, graphics, and/or text from a template page of the website.

4. The method of claim 1 wherein the step of selecting a sport from a list of sports on a landing page includes selecting a sport from a dropdown menu on the landing page.

5. The method of claim 1 wherein the step of moving saved information on the holding location includes moving thumbnail versions of stored information on the holding location of the landing page to the selected poster template.

6. The method of claim 1 including the step of uploading pictures onto the landing page from the personal computer and saving them on the holding location.

7. The method of claim 1 including the step of purchasing the completed poster from a checkout page on the website.

8. The method of claim 1 including the step of manipulating the images populating the poster template.

9. The method of claim 8 including the step of creating a preview image of the populated poster template and downloading the populated poster template to the user.

10. The method of claim 8 including the step of the completing the poster template with a desired color, text and heading of the poster from a list of font types, colors, and design elements.

11. A poster generation system, comprising:
means for accessing a poster design website on which a personalized poster can be designed;
means for selecting a sport from a list of sports on a landing page;
means for selecting a poster template on the poster design website;
means for accessing photographs of a plurality of players of the selected sport from on the internet and selecting images of particular players and moving the selected images onto a holding location on the landing page;
means for accessing a list of plays and maneuvers for the selected sport from the internet and moving the selected list of plays and maneuvers onto the holding location on the landing page;
means for retrieving the statistics of each of the selected players from the internet and moving the statistics of each of the selected players onto the holding location on the landing page;
means for accessing a trophy page showing a variety of trophies on the sport poster design website and selecting a trophy and moving the selected trophy onto the holding location on the landing page; and
means for opening the landing page and populating the selected poster template with images of the saved information on the holding location to form a completed poster.

12. The poster generation system of claim 11 wherein the means of accessing a poster design website includes accessing the World Wide Web from a personal computer.

13. The poster generation system of claim 11 wherein the means of selecting a poster template on the poster design website includes selecting a poster template adapted for occupying the poster template with images, graphics, and/or text from a template page of the website.

14. The poster generation system of claim 11 wherein the means of selecting a sport from a list of sports on a landing page includes selecting a sport from a dropdown menu on the landing page.

15. The poster generation system of claim 11 wherein the means of moving saved information on the holding location includes moving thumbnail versions of stored information on the holding location of the landing page to the selected poster template.

16. The poster generation system of claim 11 including the means of uploading pictures onto the landing page from the personal computer and saving them on the holding location.

17. The poster generation system of claim 11 including the means of purchasing the completed poster from a checkout page on the website.

18. The poster generation system of claim 11 including the means of manipulating the images populating the poster template.

19. The poster generation system of claim 18 including the means of creating a preview image of the populated poster template and downloading the populated poster template to the user.

20. The poster generation system of claim 18 including the means of completing the poster template with a desired color, text and heading of the poster from a list of font types, colors, and design elements.
